(19) United States
(12) Patent Application Publication
(10) Pub. No.: US 2024/0314054 A1
(43) Pub. Date: Sep. 19, 2024

(54) ON-DEVICE MACHINE LEARNING-BASED NETWORK BANDWIDTH PREDICTION TO IMPROVE ADAPTIVE MEDIA STREAMING PERFORMANCE

(71) Applicant: Apple Inc., Cupertino, CA (US)

(72) Inventors: Soutik CHAKRABORTY, Sunnyvale, CA (US); John Y. SU, Saratoga, CA (US); Eunhee LIM, Santa Clara, CA (US); Jacob A. BARON, Mountain View, CA (US)

(21) Appl. No.: 18/184,316

(22) Filed: Mar. 15, 2023

(51) Int. Cl. H04L 43/0888; H04L 41/16; H04L 65/60

(52) U.S. Cl. CPC H04L 43/0888; H04L 41/16; H04L 65/60

(57) ABSTRACT

A media streaming method is disclosed in which a network environment of a sink device engaged in media streaming is estimated and at least two network throughput estimates are developed. A first network throughput estimate may be estimated from a measurement of network performance and a second network throughput estimate may be developed from a correlation of the estimated network environment to a machine learning model representing network throughput predictions. A final throughput estimate may be developed from the first and second network throughput estimates; and a representation of media content may be selected for retrieval based on the final throughput estimate. The machine learning model of network throughput may be developed over the course of prior media streaming session(s) that are performed by the sink device in which network throughput performance indicators of the streaming session(s) are stored over a predetermined interval and, upon conclusion of the interval, the model of network throughput is constructed according to a machine learning technique. Both the logging network throughput performance indicators and the building of the model of network throughput may be performed solely by the sink device, which preserves confidentiality of data representing consumer behavior during those media streaming sessions.

### BACKGROUND

The present disclosure relates to network-based media streaming techniques and, in particular, to techniques for selecting from among different representations of media for download by a sink device involved in media streaming.

Network-based media players are common to modern consumer devices. When a user of a media player selects a media item to be played on their devices, the device typically retrieves a coded representation of the media item from a network source device, decodes the coded representation, and presents the decoded representation as commanded by the user (for example, by rendering the decoded representation at the device). Oftentimes, media may be made available in a variety of coded representations, which allows a sink device to select a representation that best matches its streaming environment, for example, by selecting a representation whose data rate requirements match throughput provided by a network through which a sink device accesses the media item.

A problem arises when a sink device must select a representation of media in a network environment when network throughput is unknown. Traditional techniques for estimating network throughput typically require observation of network throughput performance, which, in turn, require a sink device to exchange data with the network so that throughput performance may be measured. It often occurs that a streaming session is initiated at times where a sink device has had no meaningful opportunity to observe network performance and, therefore, the sink device has made no reliable network throughput estimates. In such cases, sink devices must select representations speculatively. For example, a sink device may select a low bitrate representation of media at the onset of the streaming session, which has a greater likelihood of being retrieved successfully over a network of unknown throughput than would a higher-bitrate representation of the media. This technique, however, would cause a lower quality-than-optimal representation of the media to be retrieved from a source device if network conditions could support retrieval of the higher bitrate segments.

### BRIEF DESCRIPTION OF THE DRAWINGS

FIG. 1 is a block diagram of a media streaming system according to an embodiment of the present disclosure.

FIG. 2 illustrates a method according to an embodiment of the present invention.

FIG. 3 illustrates a method for building a throughput model according to an embodiment of the present invention.

### DETAILED DESCRIPTION

Embodiments of the present disclosure provide a media streaming method in which a network environment of a sink device engaged in media streaming is estimated and at least two network throughput estimates are developed. A first network throughput estimate may be developed from a measurement of network performance and a second network throughput estimate may be developed from a correlation of the estimated network environment to a machine learning model representing network throughput predictions. A final throughput estimate may be developed from the first and second network throughput estimates, and a representation of media content may be selected for retrieval based on the final throughput estimate. The machine learning model of network throughput may be developed over the course of prior media streaming session(s) that are performed by the sink device in which network throughput performance indicators of the streaming session(s) are stored over a predetermined interval and, upon conclusion of the interval, the model of network throughput is constructed according to a machine learning technique. Both the logging of network throughput performance indicators and the building of the model of network throughput may be performed solely by the sink device, which preserves confidentiality of data representing consumer behavior during those media streaming sessions.

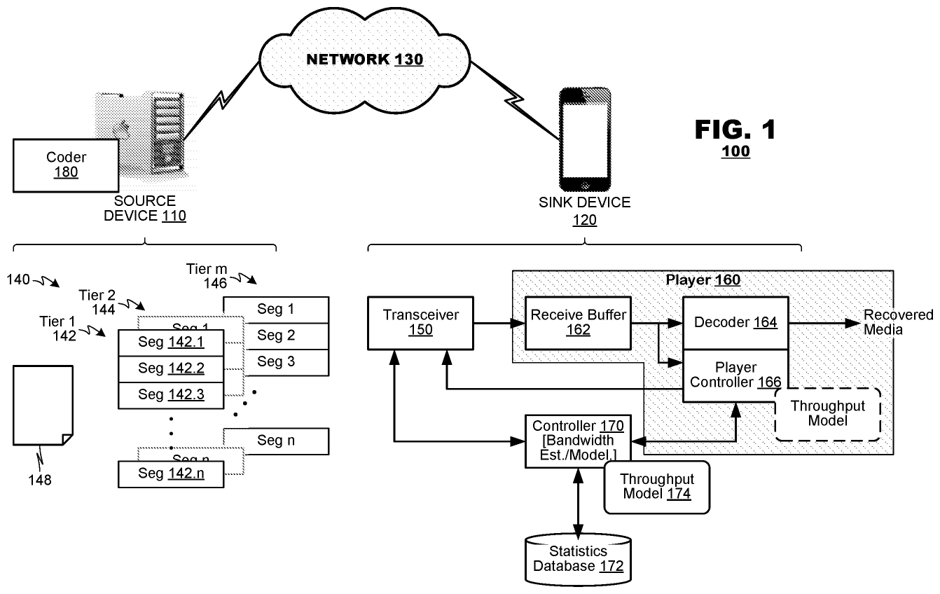

FIG. 1 is a block diagram of a media streaming system 100 according to an embodiment of the present disclosure. The system 100 may include a media source device 110 provided in communication with a media sink device 120 via a network 130. The source device 110 may supply one or more media items 140 to the sink device 120 upon request.

The source and sink devices 110, 120 may operate according to one or more interface protocols that define how media items 140 are to be represented. Many streaming protocols, such as the HTTP Live Streaming protocol, the MPEG-DASH protocol, and others, permit media publishers to offer media items 140 in a variety of coding formats and a variety of representations. FIG. 1 illustrates a format of an exemplary media item 140 suitable for use with embodiments of the present disclosure. As illustrated, content of a media item 140 may be organized into a plurality of tiers 142, 144, 146, each of which contains a plurality of segments (e.g., 142.1-142.n). Each tier 142, 144, 146 may represent common content of the media item in different ways. For example, the different tiers may represent video of the media item at different frame sizes, at different frame rates, at different bit rates, and/or using video coding protocols. Within each tier, individual segments (e.g., 142.1-142.n) may represent content of the media item over a unique temporal interval. For example, a first segment 142.1 may contain a representation of the first five seconds of the media item's content, a second segment 142.2 may contain a representation of the next five seconds of the media item's content, and so on. The final segment 142.n of the tier 142 may represent content at the end of the media item 140. The segments 142.1-142.n from one tier 142 are temporally aligned with segments from other tiers 144, 146 along a media playback timeline.

Media items 140 often contain several independent channels of content. A media item 140, for example, may contain an audio channel representing audio content of the media item and a video channel representing the media item's video content. In many applications, audio content may be represented as multi-channel audio, providing parallel channels for stereo and/or spatial audio rendering applications. And, sometimes, a media item 140 may contain different video channels that are alternatives to each other; for example, a media item may contain multiple video sequences that represent content from different viewing perspectives. In such applications, the tiers 142-146 and segments may be replicated as desired for each channel of content. Providers of source content typically will tailor the number of channels and the number of tiers for each channel to suit their individual needs. The channels are not illustrated in FIG. 1 for simplicity's sake.

A media item 140 also may include a manifest file 148, which provides information regarding the channels that are available for the media item 140, the tiers 142-146 for each channel, characteristics of each tier (e.g., the tier's frame size, coding protocol, frame rate, and bit rate), and information identifying locations where the segments are available for download.

Typically, during a media streaming session, a sink device 120 downloads the manifest file 148 for a desired media item 140, which provides information to the sink device 120 regarding the channels, tiers, and segments of the media item 140 that are available at the source device 110. Thereafter, the sink device 120 may select and download segments (e.g., segments 142.1, 142.2, etc.) that are suitable for its local environment. For example, a sink device 120 may select segments from a tier 142 that matches an estimated amount of bandwidth provided by the network 130 for the media session or that matches the type of output device to which decoded media will be output. The sink device 120 may decode the downloaded media segments and output them to an associated rendering device. In many streaming sessions, the sink device 120 is commanded to play a media item 140 from beginning to end, but this does not occur in all cases. Many sink devices 120 support streaming modes that allow users to play media content out of order, for example, by skipping among media chapters, fast-forwarding, skipping backwards, etc.

It may occur that a sink device's local environment may change, which may cause the sink device 120 to select segments from among available tiers 142, 144, 146. For example, a network 130 may become congested, which may reduce the amount of bandwidth available to the sink device 120 and may cause the sink device 120 to select segments from a tier (say, tier 144) that are coded at a lower bit rate than the segments of a previously selected tier 142. Alternatively, the sink device 120 may transition from one type of network (example, a cellular network) to another type of network (a high bandwidth wireless network) that alters communication bandwidth. It can occur also that, during a media streaming session, a sink device 120 may output decoded data to one type of display device (e.g., a relatively large standalone display device) but switch its output to another type of display device (a display on a smaller handheld device). Thus, as the sink device's local environment changes, the sink device 120 may select segments from among the tiers 142, 144, 146 to suit the changing environment.

FIG. 1 also illustrates a simplified block diagram of a sink device 120. The sink device 120 may include a transceiver 150, a media player 160, and a controller 170. A transceiver 150 within the sink device 120 may communicate with the network 130 to issue requests for and manage retrieval of segments from the source device 110. Retrieved segments may be provided to a player 160 and stored in a receive buffer 162 within the player. A decoder 164 within the player 160 may drain segment data from the receive buffer 162 and decode the data to invert coding operations performed on the segments' content before they were made available at the source device 110 (represented by coder 180). Typically, the decoding operation generates media content that resembles source media content from which the segments were generated. Depending on the compression/decompression operations 180, 164 that are used, the recovered media may possess some errors when compared to the source media prior to coding. The recovered media may be output from the player 160, for example, for consumption by a display device, for storage on the sink device 120, or for consumption by another application that executes on the sink terminal 120 (not shown). The decoder 164 may be controlled by a player controller 166 that selects operational parameters of the decoder 164 according to metadata provided by the manifest file 148 and other metadata provided in the coded segments 142.1, 142.2, . . . , 142.n that identify, for example, a compression algorithm used to generate the segments 142.1, 142.2, . . . , 142.n and coding parameters used during application of the compression algorithm. The player controller 166 may select segments to be downloaded from the source device 110 and may interface with the transceiver 150 to issue commands over the network 130 to retrieve them.

The controller 170 may operate as a bandwidth estimator that estimates network resources that are available to the player 160 by the network 130. The controller 170, for example, may collect data from the transceiver 150 representing network performance and data from the player controller 166 regarding selections of segments in response to the observed network performance. The controller 170 may compile estimates of prior network behavior and segment selections into predictions of network bandwidth, shown as a throughput model 174, which the controller 170 may apply to develop a throughput estimate for the player controller 166. The controller 170 may build the throughput model 174 from statistics 172 compiled from previous streaming sessions conducted by the sink device 120. The controller's bandwidth estimates also may integrate throughput predictions from the throughput model 174 with bandwidth estimates performed from other sources, such as network performance measured during a current streaming session. The player controller 166 may select segments 142.1, 142.2, . . . , 142.n for a new streaming session from the controller's bandwidth estimates.

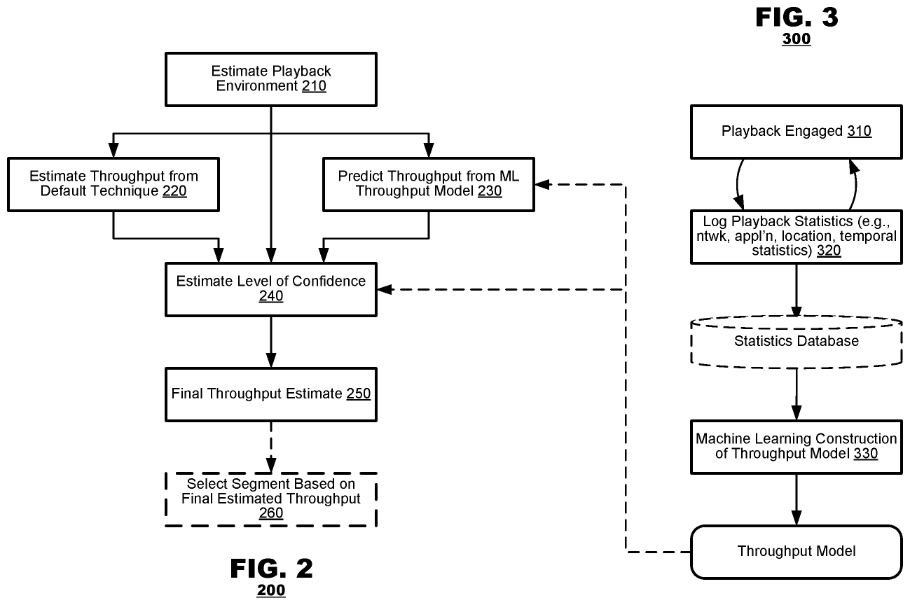

FIG. 2 illustrates a method 200 according to an embodiment of the present invention. The method 200 may operate iteratively on a sink device throughout a media streaming session. An iteration of the method 200 may begin by estimating characteristics of a playback environment (box 210). The method 200 may estimate network throughput from a default estimation technique (box 220) that represents a measurement of throughput at a sink device 120 (FIG. 1). In parallel, the method 200 may estimate network throughput from a machine learning throughput model (box 230). The method 200 may estimate a level of confidence of the two estimates (box 240) and derive a final throughput estimate (box 250) for the streaming session. The throughput estimate may be supplied to a player 160 (FIG. 1), for example, as a basis to select segments from among tiers of service 142-146 for the media streaming session. The method 200 may be repeated as desired during progression of a media streaming session, for example, at the onset of a media streaming session, each time a playback environment is estimated to change, on each interval when a player 160 selects a new segment for download from the source device 110 (FIG. 1), or on a predetermined temporal basis.

Default estimation techniques (box 220) may be performed in a variety of ways. Oftentimes, however, default estimation techniques require observation of a playback environment for a time before they develop reliable estimates. For example, a sink device 120 (FIG. 1) may measure receive data rates at a transceiver 150 as segment data is received from the network 130. Alternatively, a sink device 120 (FIG. 1) may estimate network throughput based on a state of a player's receive buffer 162. A sink device 120 may select segments from one tier (say, tier 142) on a speculative basis at the onset of a streaming session, which would cause segments to be stored in the receive buffer 162 prior to decode. The sink device 120 may compare a rate at which the segments' data enters the receive buffer 162 to a rate at which the segments' data is drained from the receive buffer 162. A comparison of these rates may lead to an estimate of network performance. In both instances, however, these estimates of network performance can begin only after download of segments has begun. The sink device 120 likely has no a priori knowledge of the network throughput before the sink device 120 requests the first segments from the source device 110.

In such an application, model-based throughput prediction (box 230) may supply a prediction of network throughput at the onset of a media streaming session. Throughput predictions may be made based, for example, on information that identifies a network 130 (FIG. 1) to which the sink device 120 is connected at the onset of the media streaming session. For example, the sink device 120 may store information that identifies the network to which it is connected, either by an identifier of the type of the connected network (e.g., WiFi vs. cellular), an identifier of the connected network (e.g., a WiFi network's name or an identifier of a cellular network service provider), or an identifier of connected network equipment (e.g., a router model or performance information, cellular tower identifiers or performance information). In such instances, the throughput model may store predictions of throughput that are correlated to such identifiers, and the method 200 may generate a throughput prediction (box 230) based on the identifiers.

Estimations of level of confidence (box 240) may be performed in a variety of ways. In one embodiment, estimates of level of confidence may be made based on an estimated reliability of the default throughput estimation technique (box 220). As explained, at the onset of a media streaming session, a default throughput estimation technique may be assigned a low level of confidence simply because the streaming session is in an early stage of operation and the default estimation technique lacks a sufficient history of network performance from which to make a reliable estimate.

Over time, when the sink device is operated in an environment with stable network throughput, reliability of the default throughput estimation technique likely will increase. The default throughput estimation technique will make throughput estimates for new media segments to be downloaded, and the method 200 may compare those throughput estimates to throughput that the sink device 120 observes as those segments are downloaded. Errors in the throughput estimates obtained by the default estimation technique may be computed, the throughput estimation may be revised, and, eventually, the throughput estimate may converge to some range that is determined to be stable. When errors in the throughput estimates converge to within a predetermined threshold value, the level of confidence assigned to the default throughput estimation technique may increase to a maximum value.

Alternatively, a level of confidence may be estimated from an estimation of correlation between characteristics of the estimated playback environment and characteristics on which the throughput model has been constructed. As explained, the throughput model may be developed from analysis of network performance observed over prior media streaming sessions, which are correlated to the networks (identified by, for example, network types and/or network names) over which those streaming sessions were conducted. The model, however, may provide a weak basis for prediction of network throughput when a new streaming session is performed in a playback environment that the sink device has never encountered (e.g., it is performed over a new type of network or a new network). Thus, correlation between estimated playback environment and characteristics on which the throughput model is constructed may form another basis to estimate a level of confidence.

Computations of final throughput estimates (box 250) also may be performed in a variety of ways. In one embodiment, a normalized level of confidence C may be computed for the default throughput estimation technique based on an estimated reliability of the default estimation technique. Throughput estimates from the two techniques (boxes 220, 230) may be weighted according to the level of confidence C, which may be assigned to the estimate obtained from the default throughput estimation technique, and a reciprocal value 1−C, which may be assigned to the estimate obtained from the model-based throughput estimation technique.

In another embodiment, the level of confidence value C may be set to zero during an initial phase of a streaming session, until actual network delivery rates have been observed for a predetermined amount of time. In this embodiment, the final throughput estimate may be obtained entirely from the model-based throughput estimation technique during this initial phase, regardless of any estimated reliability ascribed to the default throughput estimation technique.

And, of course, when a level of confidence is estimated based on a correlation between characteristics of the playback environment and network characteristics recorded in the throughput model, a normalized level of confidence C may be computed based on this correlation and the reciprocal level of confidence 1−C may be assigned to the estimation obtained from the default throughput estimation technique.

The method 200 of FIG. 2 also finds applications in circumstances where a sink device (FIG. 1) changes networks while a streaming session is underway. During a streaming session, a sink device 120 may transition from one network type to another (e.g., from a WiFi network to a cellular network) or from one network node to another (e.g., from one WiFi router or relay node to another or from one cellular tower to another in a handoff operation). These events effectively transition the sink device 120 from a first network environment for which the sink device 120 may have developed a reliable estimate of network throughput to a second network environment for which the sink device 120 where throughput is unknown. In this case, the method 200 may reset the estimated level of confidence C to a value that applies when the sink device 120 has no a priori knowledge of network throughput and perform another iteration of the method 200.

FIG. 3 illustrates a method 300 according to an embodiment of the present disclosure for building a throughput model for the method of FIG. 2. The method 300 may operate on a sink device as a background process while the sink device 120 (FIG. 1) is engaged in a streaming session (box 310). During such operations, the method 300 may collect and log statistics related to the streaming session. Typically, the method 300 collects statistics of streaming session(s) that are conducted over predetermined intervals during operation of the sink device 120. For example, the method 300 may collect statistics on session(s) conducted over a daily interval, a multi-day interval, or (for battery-operated sink devices) over intervals between device charging operations. As a result, operation of boxes 310-320 may collect statistics on multiple streaming sessions as they occur during the defined intervals, represented by the database illustrated in FIG. 3. The statistics database 172 is illustrated in FIG. 1; it may be maintained by the controller 170 (FIG. 1) during operation of the sink device 120.

The method 300 may build a throughput model using a machine learning technique (box 330) from content accumulated in the statistics database 172 (FIG. 1). A machine learning network may generate a throughput model for use in the method 200 of FIG. 2. The throughput model, for example, may generate throughput estimates that are correlated to characteristics of the playback environment that can be detected in box 210 (FIG. 2). The throughput model, therefore, may provide a basis for the method 200 to predict network throughput for a new streaming session by comparing characteristics of a playback environment detected in box 210 to environmental characteristics identified in the throughput model. The throughput model may be developed by a controller 170 of a sink device 120; it is represented as throughput model 174 in FIG. 1.

It is expected that operation of the method 300 of FIG. 3, both the collection of statistics and the development of the throughput model, will occur entirely on a sink device 120 (FIG. 1). In this manner, operation of the method 300 aligns with privacy initiatives that protect against centralized collection of consumer behavior. In this manner, the methods 200, 300 of FIGS. 2 and 3 may be applied to consumer electronic devices such as mobile phones, tablet computers, personal computers and laptops, and consumer media players without exposing collected statistics of consumer behavior (e.g., contents of the statistics database 172 (FIG. 1)) to external devices. It may occur that a single consumer will own multiple consumer devices (e.g., both a mobile phone and a tablet computer) and will have recorded its common ownership of those devices in the devices by, for example, a common user ID. In an embodiment, devices that are assigned to a common user ID may exchange compiled statistics information to compile throughput models from streaming session statistics of the common owner.

Playback statistics may be compiled (box 320) from a variety of sources. In many applications, throughput is determined to a large degree by the network 130 to which the sink device 120 is connected. The playback statistics may store network identification information such as the type of network to which the sink device is connected (e.g., WiFi, cellular, Ethernet), an identifier of the network (e.g., in a WiFi application, each WiFi network's name (a home network vs. an office network, etc.), in a cellular application, each cellular network's name and status (e.g., a home network, a roaming network), or a type of network equipment and performance standards associated with them (e.g., in an WiFi application, which revision of IEEE 802.11 is supported by the network equipment to which the sink device 120 is connected, or, in a cellular application, which interface specification (e.g., 5G, 4G, etc.) is supported). Playback statistics also may store performance information regarding those media streaming sessions, such as signal-to-noise measurements, bit error rates and other information that indicates variances of network throughput during those media streaming sessions. In many modern networking applications, it often occurs that WiFi networks provide higher network throughput to sink devices 120 than do cellular networks. WiFi equipment often supports higher data rates than cellular equipment and they often have shorter transmission paths to sink devices 120 which can lower the likelihood of transmission errors. The playback statistics database 172 may maintain information on such performance characteristics of streaming sessions.

Playback statistics also may store contextual information such the time of day in which the streaming sessions were conducted, GPS and/or micro-location(s) from which the streaming sessions were conducted, and identifiers of service providers engaged in the media streaming session. In modern streaming applications, source content providers may program their source devices to limit data rates (commonly, to “throttle” data rates) according to predetermined policies, many of which are determined by source device loading. Similarly, some network service providers such as providers of cellular services perform data rate throttling based on network loading or based on consumer network usage. In both instances, device loading events can have temporal characteristics that are determined by the timing of requests for service made from among the consuming public at large. Even in the absence of over throttling controls applied by source devices 110 or providers of network 130 services, network congestion events may cause variations in the throughput that individual sink devices 120 experience during streaming sessions; in a home WiFi network, for example, the throughput that is available to a single sink device 120 may be determined in part by demands made on the network 130 by other sink devices (not shown in FIG. 1) that compete for network throughput. Sink devices 120 (FIG. 1) may store information regarding the time(s)-of-day at which streaming sessions are conducted and the throughput that the sink device 120 observed during such streaming sessions.

Construction of the throughput model (box 330) may be performed in a variety of ways. A machine learning method may be applied to the statistics accumulated in the statistics database 172 (FIG. 1). For example, the method 300 may apply a Random Forrest machine learning technique (discussed, at the time of this writing, at https://www.stat.berkeley.edu/˜breiman/RandomForests/), a Gradient Boosted Tree algorithm (discussed at https://jerryfriedman.su.domains/ftp/trebst.pdf), or a Neural Network algorithm to build a throughput model from the accumulated statistics. In practice, the machine learning algorithm may build the throughput model at times when the sink device 120 ordinarily is inactive, such as in an overnight update cycle.

The foregoing discussion has presented the methods 200, 300 of FIGS. 2 and 3 for application in a controller 170 (FIG. 1) that operates as a processing element that is separate from a controller 166 of a player 160. As illustrated, the controller 170 provides bandwidth estimates to the player controller 166, and the player controller 166 selects segments for retrieval based on the throughput estimates. In another embodiment (shown in phantom in FIG. 1), the controller's throughput model may be integrated with the player controller 166. In such an application, the method 200 (FIG. 2) may select a segment based on the final estimated throughput determined in box 250 (box 260).

In this embodiment, statistics logged in boxes 310-320 (FIG. 3) may include information that identify characteristics of segments downloaded during prior media streaming sessions, including, for example, the bit rates of the segments, the rendering characteristics of recovered media (e.g., a size of display during rendering, a number of audio channels rendered, etc.), and/or coding formats of segments (which determines a selection of decoding type by the decoder 164). In such an application, the throughput model may correlate characteristics of network environment(s) to characteristics of media segments that are appropriate for such environments. When the method 200 (FIG. 2) estimates the playback environment (box 210) and predicts throughput, the prediction may include an evaluation of segment characteristics for a media item 140 to be played during the new streaming session as represented in the media item's manifest file 148 and a prediction of segments to be retrieve based on a correlation between those characteristics and characteristics of segments as represented in the throughput model.

The foregoing discussion has described operation of the embodiments of the present disclosure in the context of source and sink devices. Commonly, these components are provided as electronic devices. Sink devices and the controllers and players that operate within them can be embodied in integrated circuits, such as application specific integrated circuits, field programmable gate arrays and/or digital signal processors. Alternatively, they can be embodied in computer programs that execute on personal computers, notebook computers, tablet computers, mobile devices, media players and other consumer devices. Such computer programs typically are stored in physical storage media such as electronic-, magnetic-and/or optically-based storage devices, where they are read to a processor and executed. And, of course, these components may be provided as hybrid systems that distribute functionality across dedicated hardware components and programmed general-purpose processors, as desired.

The foregoing description has been presented for purposes of illustration and description. It is not exhaustive and does not limit embodiments of the disclosure to the precise forms disclosed. Modifications and variations are possible in light of the above teachings or may be acquired from the practicing embodiments consistent with the disclosure. Unless described otherwise herein, any of the methods may be practiced in any combination.

1. A media streaming method, comprising, on a sink device:
estimating a network environment of a sink device engaged in media streaming;
developing a first network throughput estimate from measurement of network performance;
developing a second network throughput estimate from a correlation of the estimated network environment to a machine learning model representing network throughput predictions developed by the sink device;
developing a final throughput estimate from the first and second network throughput estimates; and
selecting a representation of media content for retrieval based on the final throughput estimate.

2. The method of claim 1, wherein developing the final throughput estimate includes weighting the first and second network throughput estimates according to a level of confidence from an estimated reliability of the first network throughput estimate.

3. The method of claim 2, wherein the level of confidence is assigned as a minimal value at an onset of a media streaming session.

4. The method of claim 2, wherein the level of confidence is estimated from a computation of throughput error estimates over the course of a media streaming session.

5. The method of claim 1, wherein developing the final throughput estimate includes weighting the first and second network throughput estimates according to a level of confidence from the correlation of the estimated network environment to a machine learning model.

6. The method of claim 1, wherein the estimation of the network environment includes identifying a type of a network to which the sink device is connected, and the correlation determines a correlation between the network type and network type(s) identified by the machine learning model.

7. The method of claim 1, wherein the estimation of the network environment includes identifying a name of a network to which the sink device is connected, and the correlation determines a correlation between the network name and network name(s) identified by the machine learning model.

8. The method of claim 1, wherein the estimation of the network environment includes identifying a service provider associated with a network to which the sink device is connected, and the correlation determines a correlation between the service provider identifier and service provider identifier(s) identified by the machine learning model.

9. A media streaming sink device, comprising:
a transceiver for operative connection to a communication network,
a media player, including a media decoder and a player controller to select segments of a media item for retrieval by the transceiver according to a final throughput estimate and to decode by the media decoder, and
a bandwidth estimator adapted to:
estimate a network environment of a sink device engaged in media streaming;
develop a first network throughput estimate from measurement of network performance;
develop a second network throughput estimate from a correlation of the estimated network environment to a machine learning model representing network throughput predictions, the model developed by the sink device; and
develop the final throughput estimate from the first and second network throughput estimates.

10. The device of claim 9, wherein developing the final throughput estimate includes weighting the first and second network throughput estimates according to a level of confidence from an estimated reliability of the first network throughput estimate.

11. The device of claim 10, wherein the level of confidence is assigned as a minimal value at an onset of a media streaming session.

12. The device of claim 10, wherein the level of confidence is estimated from a computation of throughput error estimates over the course of a media streaming session.

13. The device of claim 9, wherein the bandwidth estimator is integrated into the player controller.

14. The device of claim 9, wherein the bandwidth estimator is provided in a processing device external to the player controller.

15. The device of claim 9, wherein developing the final throughput estimate includes weighting the first and second network throughput estimates according to a level of confidence from the correlation of the estimated network environment to a machine learning model.

16. The device of claim 9, wherein the estimation of the network environment includes identifying a type of a network to which the sink device is connected, and the correlation determines a correlation between the network type and network type(s) identified by the machine learning model.

17. The device of claim 9, wherein the estimation of the network environment includes identifying a name of a network to which the sink device is connected, and the correlation determines a correlation between the network name and network name(s) identified by the machine learning model.

18. The device of claim 9, wherein the estimation of the network environment includes identifying a service provider associated with a network to which the sink device is connected, and the correlation determines a correlation between the service provider identifier and service provider identifier(s) identified by the machine learning model.

19. A computer readable medium storing program instructions that, when executed by a processing device of a sink device, cause the processing device to:
estimate a network environment of a sink device engaged in media streaming;
develop a first network throughput estimate from measurement of network performance;
develop a second network throughput estimate from a correlation of the estimated network environment to a machine learning model representing network throughput predictions, the model developed by the sink device;
develop the final throughput estimate from the first and second network throughput estimates; and
select a representation of media content for retrieval based on the final throughput estimate.

20. A method of building a model of network throughput for prediction of media streaming throughput, comprising, at a sink device:
over the course of media streaming session(s) that occur in a predetermined interval, logging network throughput performance indicators of the streaming session(s); and
upon conclusion of the interval, building the model of network throughput according to a machine learning technique;
wherein the logging network throughput performance indicators and the building of the model of network throughput are processing operations performed solely by the sink device.

21. The method of claim 20, wherein the network throughput performance indicators include, for one of the media streaming session(s) that occurs in the predetermined interval, an identifier of a type of network involved in the one media streaming session.

22. The method of claim 20, wherein the network throughput performance indicators include, for one of the media streaming session(s) that occurs in the predetermined interval, a name of a network involved in the one media streaming session.

23. The method of claim 20, wherein the network throughput performance indicators include, for one of the media streaming session(s) that occurs in the predetermined interval, an identifier of network equipment involved in the one media streaming session.

24. The method of claim 20, wherein the network throughput performance indicators include, for one of the media streaming session(s) that occurs in the predetermined interval, an identifier of a service provider that provides network services for the one media streaming session.

25. The method of claim 20, wherein the network throughput performance indicators include, for one of the media streaming session(s) that occurs in the predetermined interval, an identifier of a service provider that provides the media for the one media streaming session.

26. The method of claim 20, wherein the network throughput performance indicators include, for one of the media streaming session(s) that occurs in the predetermined interval, a time-of-day of the one media streaming session.

27. The method of claim 20, wherein the machine learning technique is a Random Forest-based technique.

28. The method of claim 20, wherein the machine learning technique is a Gradient Boosted Tree-based technique.

29. The method of claim 20, wherein the machine learning technique is a neural network-based technique.
